(19) United States
(12) Patent Application Publication
(10) Pub. No.: US 2006/0127060 A1
(43) Pub. Date: Jun. 15, 2006

(54) Method and apparatus for calculating length of media contents including in multimedia contents

(75) Inventors: Ju-han Lee, Suwon-si (KR); Ji-hoon Kim, Hwaseong-si (KR); Seung-gi Chang, Seoul (KR); Alexandre Magzoumov, Suwon-si (KR); Jun-hae Choi, Seongnam-si (KR); Ho-jeong You, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/288,299

(22) Filed: Nov. 29, 2005

Related U.S. Application Data
(60) Provisional application No. 60/631,139, filed on Nov. 29, 2004.

(30) Foreign Application Priority Data
Feb. 23, 2005 (KR) 10-2005-0015054

(51) Int. Cl. H04N 5/781

(52) U.S. Cl. 386/125; 386/126

(57) ABSTRACT

A method of providing media contents in a wired/wireless network environment and an apparatus using the same. The method includes: calculating the length of multimedia contents; calculating a length of information included in the multimedia contents; and calculating the length of the media contents included in the multimedia contents from the length of the multimedia contents and the length of the information. In a real time transcoding incapable of calculating a far end of media contents, a length of the media contents can be provided to a digital media client.

### BACKGROUND OF THE INVENTION

This application claims the benefit of U.S. Provisional Application No. 60/631,139, filed on Nov. 29, 2004 in the U.S. Patent and Trademark Office, and Korean Patent Application No. 10-2005-0015054, filed on Feb. 23, 2005 in the Korean Intellectual Property Office, the disclosures of which are incorporated herein in their entirety by reference.

### FIELD OF THE INVENTION

Apparatuses and methods consistent with the present invention relate to providing media contents in a wired/wireless network environment.

### DESCRIPTION OF THE RELATED ART

The Digital Living Network Alliance (DLNA) was formed by electronic appliance manufactures to secure a seamless multimedia contents transfer between consumer electronics (CE), personal computers (PC), mobile terminals, etc. in a wired/wireless network environment.

In particular, Home Network Guideline version 1.0 (HNv1) suggested by the DLNA (hereinafter referred to as “DLNA HNv1”) specifies communications between a digital media server and a digital media client. According to the DLNA HNv1, an Internet protocol (IP) is used as a network layer, a transmission control protocol (TCP) is used as a transmission layer, and a hypertext transfer protocol (HTTP) is used as an application layer. The DLNA HNv1 specifies that if the digital media client requests media contents for the digital media server using a header or GET of the HTTP, the digital media server provides a length of media contents to the digital media client as follows.

HTTP/1.1 200 OK

Date: Sun, 28 Nov. 28 2004 16:25:22 GMT

Content Length: 15044392

Content Type: video/mpeg

The digital media client can calculate an amount of data to be received in advance using the length information of the media contents. The calculated amount of data can be used to efficiently perform a buffer management of the digital media client.

The DLNA HNv1 specifies that the digital media server does not provide the length of media contents to the digital media client when the digital media server is a live stream incapable of understanding a far-end of media contents or a real time transcoding incapable of calculating the far end of media contents as follows.

HTTP/1.1 200 OK

Date: Sun, 28 Nov. 28 2004 16:25:22 GMT

Content Type: video/mpeg

However, if the digital media server does not provide the length of media contents to the digital media client, the digital media client cannot calculate the amount of data to be received in advance and efficiently manage a buffer.

### SUMMARY OF THE INVENTION

The present invention provides a method of providing a length of media contents to a digital media client by a digital media server in a real time transcoding which makes it difficult to calculate a far end of the media contents and an apparatus using the same.

The present invention also provides a computer readable medium having embodied thereon a computer program for executing the method.

According to an aspect of the present invention, there is provided a method of providing media contents, the method comprising: parsing multimedia contents; calculating a length of media contents included in the multimedia contents based on the result obtained by the parsing; and transferring the calculated length of the media contents and the media contents.

According to another aspect of the present invention, there is provided a server comprising: a parsing unit parsing multimedia contents; a calculating unit calculating a length of media contents included in the multimedia contents based on the result obtained by the parsing; and a transferring unit transferring the calculated length of the media contents and the media contents.

According to another aspect of the present invention, there is provided a computer-readable storage medium having embodied thereon a computer program for executing the method of providing media contents.

According to another aspect of the present invention, there is provided a method of calculating a length of media contents, the method comprising: calculating the length of multimedia contents; calculating a length of information included in the multimedia contents; and calculating the length of the media contents included in the multimedia contents from the length of the multimedia contents and the length of the information.

According to another aspect of the present invention, there is provided an apparatus for calculating a length of media contents, the apparatus comprising: a first calculating unit calculating the length of multimedia contents; a second calculating unit calculating a length of information included in the multimedia contents; and a third calculating unit calculating the length of the media contents included in the multimedia contents from the length of the multimedia contents and the length of the information.

According to another aspect of the present invention, there is provided a computer-readable storage medium having embodied thereon a computer program for executing the method of calculating a length of media contents.

### BRIEF DESCRIPTION OF THE DRAWINGS

The above and other aspects of the present invention will become more apparent by describing in detail exemplary embodiments thereof with reference to the attached drawings in which:

FIG. 1 illustrates a structure of a home network system according to an exemplary embodiment of the present invention;

FIG. 2 illustrates a volume structure of a digital versatile disc (DVD);

FIG. 3 illustrates a structure of a video manager (VMG) and a video title set (VTS) shown in FIG. 2;

FIG. 4 illustrates a detailed structure of VTSTT_VOBS (VTS Title_VOBS) shown in FIG. 3;

FIG. 5 illustrates a detailed structure of VTSM_VOBU_ADMAP shown in FIG. 3;

FIG. 6 illustrates a detailed structure of a length calculating unit shown in FIG. 1;

FIG. 7 is a flowchart of a method of providing media contents according to an exemplary embodiment of the present invention; and

FIG. 8 is a flowchart of a method of calculating a length of media contents according to an exemplary embodiment of the present invention.

### DETAILED DESCRIPTION OF EXEMPLARY EMBODIMENTS OF THE INVENTION

The present invention will now be described more fully with reference to the accompanying drawings.

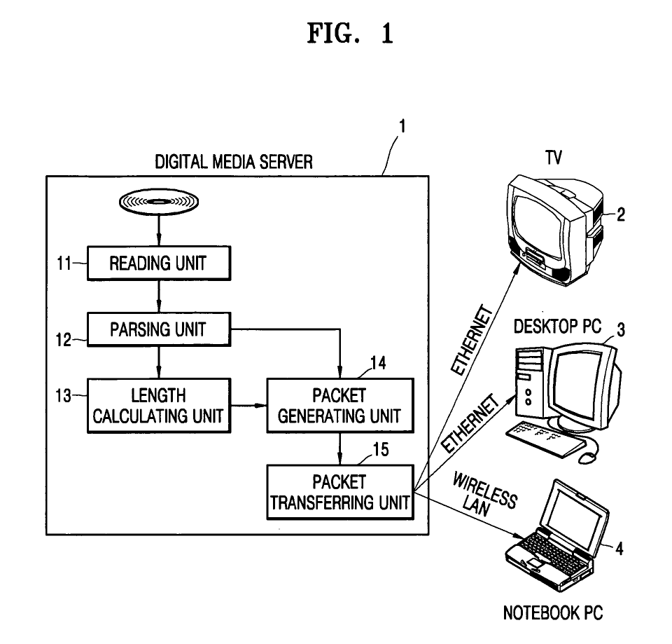

FIG. 1 illustrates a structure of a home network system according to an exemplary embodiment of the present invention. Referring to FIG. 1, the home network system comprises a digital media server 1, a television (TV) 2 corresponding to a digital media client, a desktop PC 3, and a notebook PC 4 according to the DLNA HNv1.

According to the DLNA HNv1, the digital media server 1, the TV 2, the desktop PC 3, and the notebook PC 4 use the IP as a network layer, a the TCP as a transmission layer, and the HTTP as an application layer. In particular, the digital media server 1, the TV 2, and the desktop PC 3 use Ethernet which is a kind of a wired LAN as a link layer. The digital media server 1 and the notebook PC 4 use an Institute of Electrical and Electronics Engineers (IEEE) 802.11 which is a kind of a wireless LAN as the link layer.

The digital media server 1 comprises a reading unit 11, a parsing unit 12, a length calculating unit 13, a packet generating unit 14, and a packet transferring unit 15.

The reading unit 11 reads media contents and multimedia contents including information on the media contents from a digital versatile disc (DVD). Generally, the media contents are called video data, and may be audio data, image data, etc. In particular, according to the DLNA HNv1, video data is composed of Moving Picture Experts Group (MPEG)-2 program streams (PSs).

The parsing unit 12 parses the multimedia contents read by the reading unit 12, thereby recognizing a recording structure of the multimedia contents. The recording structure of the multimedia contents on the DVD will be described below.

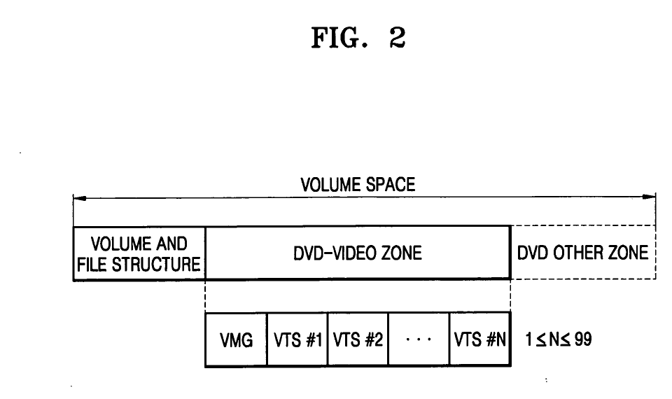

FIG. 2 illustrates a volume structure of the DVD. Referring to FIG. 2, the volume space of the DVD is composed of a volume/file structure region on which a universal disc format (UDF) bridge structure is recorded, a DVD video region on which video data is recorded, and other regions. To be more specific, the DVD video region includes a video manager (VMG) on which control information necessary for reproducing video data is recorded and 99 video title sets (VTSs).

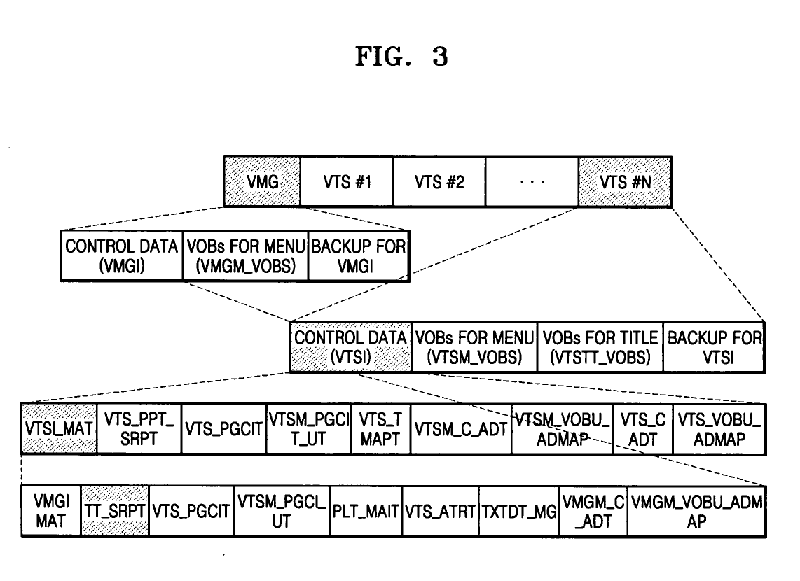

FIG. 3 illustrates a structure of the VMG and the VTS shown in FIG. 2. Referring to FIG. 3, the VMG comprises video manager information (VMGI), a video manager menu_video object set (VMGM_VOBS), and a VMGI backup. To be more specific, the VMG comprises VMGI_MAT(VMGI_Management Table), TT_SRPT(Title_Search Pointer Table), VTS_PGCIT(VTS_Program Chain Information Table), VMGM_PGCI_UT(VMGM_Program Chain Information_Unit Table), PLT_MAIT(Parental_Management Information Table), VTS_ATRT(VTS_Attribute Table), TXTDT_MG(Text Data_Manager), VMGM_C_ADT(VMGM_Cell_Address Table), VMGM_VOBU_ADMAP(VMGM_Video Object Unit_Address Map).

The VTS comprises VTSI (VTS Information), VTSM_VOBS (VTS Menu_VOBS), VTSTT_VOBS (VTS Title_VOBS), and a VTSI backup. To be more specific, the VTSI comprises a VTSI_MAT (VTS Information Management Table), VTS_PTT_SRPT (VTS_Part Title_SRPT), VTS_PGCIT, VTSM_PGCIT_UT, VTS_TMAPT (VTS_Time Table Map), VTSM_C_ADT, and VTSM_VOBU_ADMAP. The media contents are recorded on the VTSTT_VOBS.

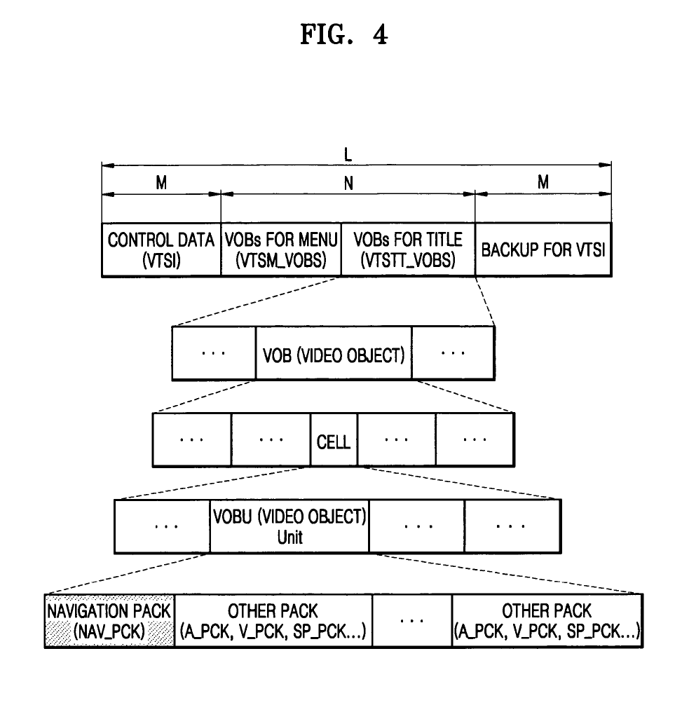

FIG. 4 illustrates a detailed structure of the VTSTT_VOBS shown in FIG. 3. Referring to FIG. 4, the VTSTT_VOBS comprises a plurality of Video Objects (VOBs), each of the plurality of VOBs comprises a plurality of cells, and each of the plurality of cells comprises a plurality of VOBUs. Each of the plurality of VOBUs comprises navigation packs and packs on which media contents are recorded. As shown in FIG. 4, one VOBU must include one navigation pack on which the media contents are not recorded. Therefore, the length of the media contents can be calculated by subtracting the length of navigation packs by the number of the plurality of VOBUs from the length of the VOB.

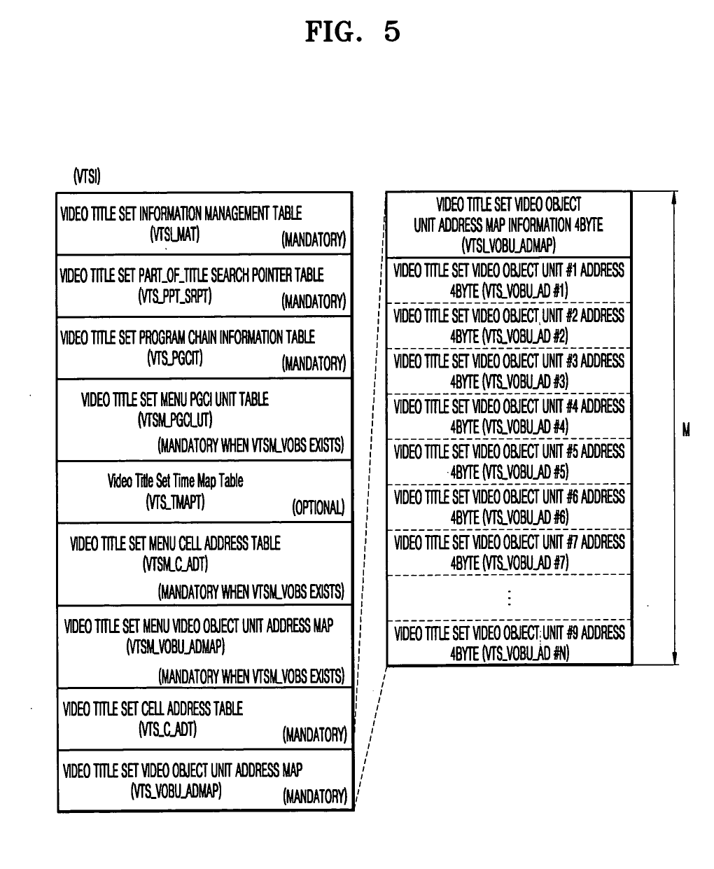

FIG. 5 illustrates a detailed structure of the VTSM_VOBU_ADMAP shown in FIG. 3. Referring to FIG. 5, the VTSM_VOBU_ADMAP comprises VTSM_VOBU_ADMAPI(VTSM_VOBU_ADMAP Information) and the n number of VTS_VOBU_AD(VTS_VOBU_Address).

The length calculating unit 13 calculates the length of the media contents included in multimedia contents based on the result obtained by the parsing in the parsing unit 12. To be more specific, the length calculating unit 13 calculates the length of the media contents recorded on the DVD video region based on information recorded on the DVD video region obtained by the parsing in the parsing unit 12.

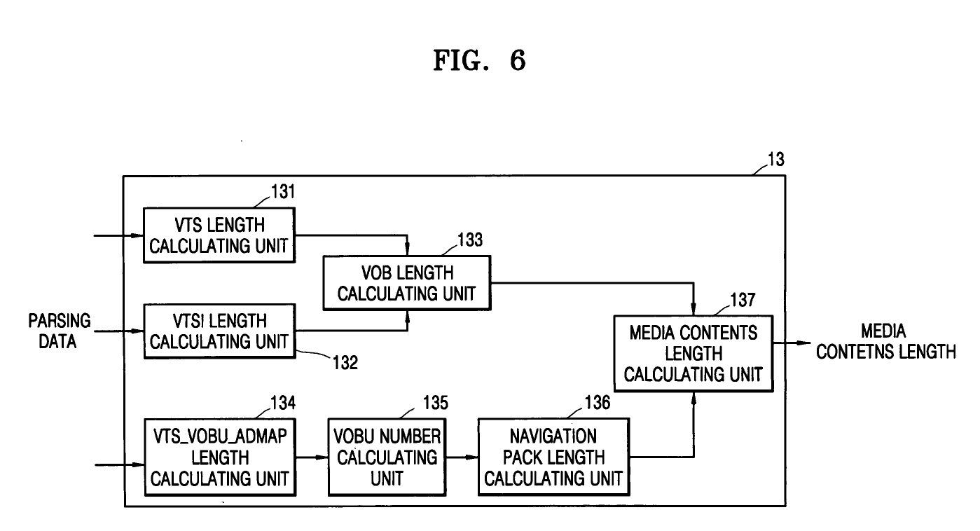

FIG. 6 illustrates a detailed structure of the length calculating unit 13 shown in FIG. 1. Referring to FIG. 6, the length calculating unit 13 comprises a VTS length calculating unit 131, a VTSI length calculating unit 132, a VOB length calculating unit 133, a VTS_VOBU_ADMAP length calculating unit 134, a VOBU number calculating unit 135, a navigation pack length calculating unit 136, and a media contents length calculating unit 137.

The VTS length calculating unit 131 calculates each length of VTSs from each start point and each end point of VTSs among the information recorded on the DVD video region. Each start point of VTSs is recorded on the TT_SRPT and each end point of VTSs is recorded on the VTSI_MAT as shown in FIG. 3. That is, the VTS length calculating unit 131 calculates each length of VTSs by subtracting each start point of VTSs recorded on the TT_SRPT from each end point of the VTSs recorded on the VTSI_MAT.

The VTSI length calculating unit 132 calculates each length of VTSIs from each start point of the VTSs and each end point of the VTSIs among the information recorded on the DVD video region. Each start point of VTSs is recorded on the TT_SRPT and each end point of the VTSIs is recorded on the VTSI_MAT as shown in FIG. 3. That is, the VTSI length calculating unit 132 calculates each length of the VTSIs by subtracting each start point of the VTSs recorded on the TT_SRPT from each end point of VTSIs recorded on the VTSI_MAT.

The VOB length calculating unit 133 calculates the length of the VOB from the lengths of the VTSs and VTSIs calculated in the VTS length calculating unit 131 and the VTSI length calculating unit 132 as follows:
N=(L−2×M)×2048 (1)

Referring to FIG. 4, L denotes the length of the VTS, M denotes the length of the VTSI, and N denotes the length of the VOB. The VOB length calculating unit 133 subtracts M twice from L and multiplies 2048 to the subtracted value to calculate the length of the VOB. The unit of N is a byte and the unit of L and M is a sector. The length of a sector of the DVD (i.e., 2048 bytes) is multiplied to (L−2×M). When an temporary file is burned in the DVD, since a file is allocated to a VTS and the VTS does not include the VTSM_VOBS, the length of the VTSM_VOBS is not considered in the present exemplary embodiment. Those having ordinary skill in the art can easily calculate the length of the VOB based on the length of the VTSM_VOBS.

The VTS_VOBU_ADMAP length calculating unit 134 calculates the length of VTS_VOBU_ADMAP of each of the VTSIs from a start point of VTS_VOBU_ADMAP of each of the VTSIs and an end point of VTS_VOBU_ADMAP of each of the VTSIs among the information recorded on the DVD video region. The start point of VTS_VOBU_ADMAP of each of the VTSIs and the end point of VTS_VOBU_ADMAP of each of the VTSIs are recorded on the VTSI_MAT as shown in FIG. 3. That is, the VTS_VOBU_ADMAP length calculating unit 134 calculates the length of VTS_VOBU_ADMAP of each of the VTSIs by subtracting the start point of VTS_VOBU_ADMAP of each of the VTSIs recorded on the VTSI_MAT from the end point of VTS_VOBU_ADMAP of each of the VTSIs recorded on the VTSI_MAT.

The VOBU number calculating unit 135 calculates the number of the VOBs from the lengths of the VTS_VOBU_ADMAP and the VTS_VOBU_ADMAPI calculated in the VTS_VOBU_ADMAP length calculating unit 134 as follows:
N=(M−4)/4 (2)

Referring to FIG. 5, M denotes the length of the VTS_VOBU_ADMAP and 4 is the length of the VTS_VOBU_ADMAPI. The length of the N number of VTS_VOBU_ADs is all 4 bytes. Since the number of the VTS_VOBU_ADs is identical to that of the VOBUs. The VOBU number calculating unit 135 calculates the length of the VOUBs by subtracting 4 from M and dividing the subtracted value by 4.

The navigation pack length calculating unit 136 calculates the total length of navigation packs included in each of the VOUBs from the number of the VOUBs calculated in the VOBU number calculating unit 135. Since each length of the navigation packs is all 2048 bytes, the navigation pack length calculating unit 136 calculates the total length of navigation packs included in each of the VOUBs by multiplying 2048 to the number of the VOBUs calculated in the VOBU number calculating unit 135.

The media contents length calculating unit 137 calculates the length of the media contents from the length of the VOUBs calculated in the VOB length calculating unit 133 and the total length of the navigation packs calculated in the navigation pack length calculating unit 136. The media contents length calculating unit 137 subtracts the total length of the navigation packs from the calculated length of the VOUBs to calculate the length of the media contents.

Referring to FIG. 1, the packet generating unit 14 generates a packet including a header on which the length of the media contents calculated in the length calculating unit 13 is recorded and a payload on which a part of the media contents is recorded. According to the DLNA HNv1, the packet generating unit 14 generates headers including an IP header, a TCP header, and an HTTP header. In particular, the length of the media contents is recorded on the HTTP header.

The packet transferring unit 15 transfers packets generated in the packet generating unit 14 to a device for reproducing a part of the media contents, i.e., the TV 2 corresponding to the digital media client, the desktop PC 3, and/or the notebook PC 4. According to the DLNA HNv1, the packet transferring unit 15 transfers the media contents and the length of the media contents using the HTTP.

The TV 2, the desktop PC 3, and the notebook PC 4 receive the media contents and the length of the media from the digital media server 1, thereby efficiently managing a buffer for storing the media contents.

In particular, when media contents are composed of MPEG-2 PSs, since multimedia contents recorded on the DVD contain navigation information on the MPEG-2 PSs besides the MPEG-2 PSs, the digital media server 1 reads the multimedia contents from the DVD and media contents are provided from the read multimedia contents, which is regarded as the real time transcoding. According to the present exemplary embodiment, the digital media server 1 provides the length of the media contents, thereby efficiently managing a buffer of the digital media client.

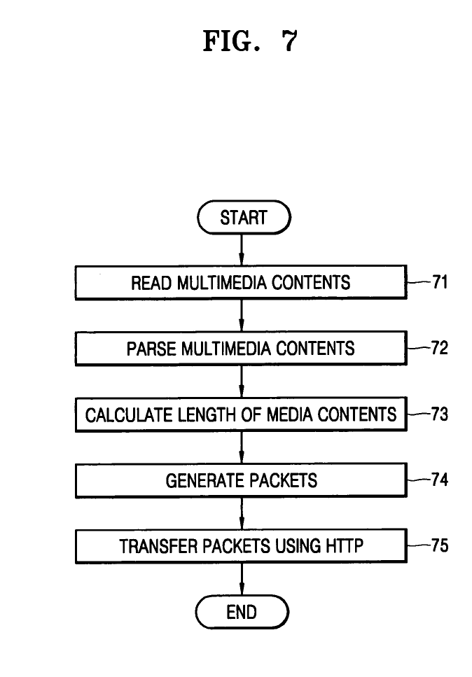

FIG. 7 is a flowchart of a method of providing media contents according to an exemplary embodiment of the present invention. Referring to FIG. 7, the method of providing media contents is performed in the digital media server 1 shown in FIG. 1 on the basis of time series. Therefore, the technical contents relating to the digital media server 1 are applied to the method of providing media contents.

In Operation 71, the digital media server 1 reads the media contents and multimedia contents including information on the media contents from a DVD.

In Operation 72, the digital media server 1 parses the multimedia contents read in Operation 72 and recognizes the recording structure of the multimedia contents.

In Operation 73, the digital media server 1 calculates the length of the media contents included in the multimedia contents based on the result obtained by the parsing in Operation 72. To be more specific, the digital media server 1 calculates the length of the media contents recorded on a DVD video region based on information recorded on the DVD video region resulting from the parsing in Operation 72.

In Operation 74, the digital media server 1 generates a packet including a header on which the length of the media contents obtained by the calculating in Operation 73 is recorded and a payload on which the media contents is recorded. According to the DLNA HNv1, the digital media server 1 generates headers including an IP header, a TCP header, and an HTTP header. In particular, the length of the media contents is recorded on the HTTP header.

In Operation 75, the digital media server 1 transfers the packet generated in Operation 87 to a device for reproducing the part of the media contents, i.e., the TV 2 corresponding to the digital media client, the desktop PC 3, and/or the notebook PC 4. According to the DLNA HNv1, the digital media server 1 transfers the media contents and the length of the media contents using the HTTP.

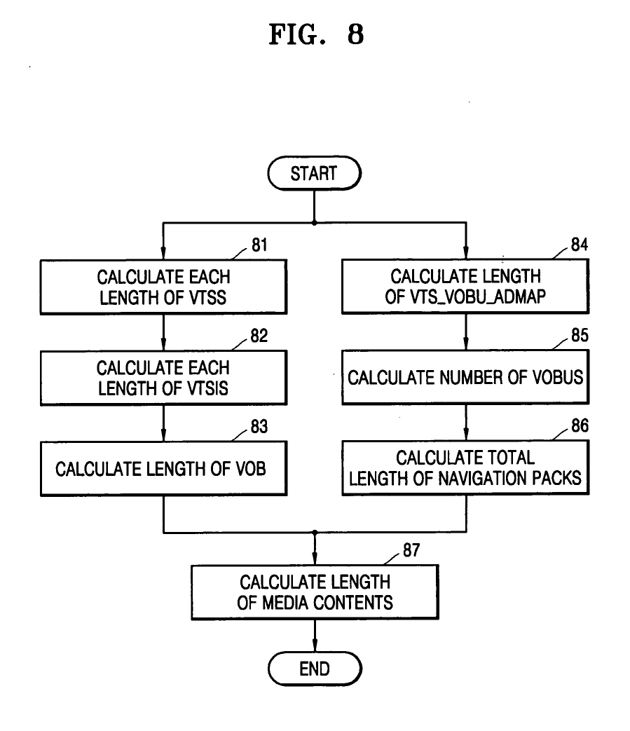

FIG. 8 is a flowchart of a method of calculating a length of media contents according to an exemplary embodiment of the present invention. Referring to FIG. 8, the method of calculating the length of media contents is performed in the length calculating unit 13 shown in FIG. 6 on the basis of time series. Therefore, the technical contents relating to the length calculating unit 13 are applied to the method of calculating the length of media contents.

In Operation 81, the length calculating unit 13 calculates each length of VTSs from each start point of VTSs to each end point of VTSs among information recorded on a DVD video region.

In Operation 82, the length calculating unit 13 calculates each length of VTSIs from each start point of VTSs to each end point of VTSIs among information recorded on the DVD video region.

In Operation 83, the length calculating unit 13 calculates a length of VOB from each length of VTSs resulting from Operation 81 and each length of VTSIs resulting from Operation 82.

In Operation 84, the length calculating unit 13 calculates a length of VTS_VOBU_ADMAP of each VTS from a start point of VTS_VOBU_ADMAP of each VTSI to an end point of each VTSI among information recorded on the DVD video region.

In Operation 85, the length calculating unit 13 calculates the number of VOBUs from the lengths of VTS_VOBU_ADMAP and VTS_VOBU_ADMAPI resulting from Operation 84.

In Operation 86, the length calculating unit 13 calculates the total length of navigation packs included in each VOBU from the number of VOBUs resulting from Operation 85.

In Operation 87, the length calculating unit 13 calculates the length of media contents from the length of VOB resulting from Operation 83 and the total length of navigation packs resulting from Operation 86.

It is possible for the present invention to be realized on a computer-readable recording medium as a computer-readable code. Computer-readable recording mediums include every kind of recording device that stores computer system-readable data. ROMs, RAMs, CD-ROMs, magnetic tapes, floppy discs, optical data storage, etc. are used as a computer-readable recording medium. Computer-readable recording mediums can also be realized in the form of a carrier wave (e.g., transmission through the Internet).

According to the present invention, when a digital media server or performs a real time transcoding incapable of calculating the far end of media contents, for example, reading multimedia contents from a DVD and providing media contents from the multimedia contents, it can provide a length of the media contents to a digital media client. The digital media client is provided with the length of most media contents including MPEG-2 PS from the digital media server, thereby efficiently managing a buffer.

While the present invention has been particularly shown and described with reference to exemplary embodiments thereof, it will be understood by those skilled in the art that various changes in form and details may be made therein without departing from the spirit and scope of the invention as defined by the appended claims.

What is claimed is:

1. A method of providing media contents, the method comprising:
parsing multimedia contents;
calculating a length of media contents included in the multimedia contents based on a result obtained by the parsing; and
transferring the media contents and the calculated length of the media contents.

2. The method of claim 1, wherein the length of the media contents is calculated based on information on the media contents.

3. The method of claim 2, wherein the multimedia contents are recorded on a digital versatile disc (DVD), and
the length of the media contents recorded on a DVD video region of the DVD is calculated based on information recorded on the DVD video region.

4. The method of claim 1, wherein the media contents and the calculated length of the media contents are transferred using a Hypertext Transfer Protocol.

5. The method of claim 1, the transferring comprises generating a packet including a header on which the length of the media contents is recorded and payload on which the media contents is recorded, and
transferring the generated packets to a device for reproducing the media contents.

6. The method of claim 5, wherein the header is a Hypertext Transfer Protocol header.

7. A server comprising:
a parsing unit which parses multimedia contents;
a calculating unit which calculates a length of media contents included in the multimedia contents based on a result obtained by the parsing of the multimedia contents by the parsing unit; and
a transferring unit which transfers the calculated length of the media contents and the media contents.

8. The sever of claim 7, wherein the calculating unit calculates the length of the media contents based on information on the media contents.

9. The sever of claim 8, wherein the multimedia contents are recorded on a DVD, and the calculating unit calculates the length of the media contents recorded on a DVD video region of the DVD based on information recorded on the DVD video region.

10. A computer-readable storage medium having embodied thereon a computer program for executing a method of providing media contents, the method comprising:
parsing multimedia contents;
calculating a length of media contents included in the multimedia contents based on a result obtained by the parsing; and
transferring the calculated length of the media contents and the media contents.

11. A method of calculating a length of media contents, the method comprising:
calculating a length of multimedia contents;
calculating a length of information included in the multimedia contents; and
calculating the length of the media contents included in the multimedia contents from the length of the multimedia contents and the length of the information.

12. The method of claim 11, wherein the multimedia contents are video title sets (VTSs) recorded on a digital versatile disc (DVD).

13. The method of claim 12, wherein the calculating the length of multimedia contents comprises:
calculating each length of the VTSs from each start point of the VTSs and each end point of the VTSs among the information;
calculating each length of VTS information (VTSIs) from each start point of the VTSs and each end point of the VTSIs among the information; and
calculating a length of a Video Object (VOB) from the calculated length of the VTSs and the calculated length of the VTSIs.

14. The method of claim 13, wherein the calculating the length of the information included in the multimedia contents comprises:
calculating a length of VTS_Video Object Unit_Address Map (VTS_VOBU_ADMAP) of each VTS from a start point of VTS_VOBU_ADMAP of each VTSI and an end point of each VTSI among the information;
calculating a number of VOBUs from the lengths of VTS_VOBU_ADMAP and VTS_VOBU_Address Map Information (VTS_VOBU_ADMAPI); and
calculating a total length of navigation packs included in each VOBU from the number of VOBUs.

15. The method of claim 14, wherein the calculating the length of the media contents comprises calculating the length of media contents from the length of the VOB and the total length of navigation packs.

16. An apparatus for calculating a length of media contents, the apparatus comprising:
a first calculating unit which calculates a length of multimedia contents;
a second calculating unit which calculates a length of information included in the multimedia contents; and
a third calculating unit which calculates the length of the media contents included in the multimedia contents from the length of the multimedia contents and the length of the information.

17. The apparatus of claim 16, wherein the multimedia contents are video title sets (VTSs) recorded on a digital versatile disc (DVD).

18. A computer-readable storage medium having embodied thereon a computer program for executing the method of calculating a length of media contents, the method comprising:
calculating a length of multimedia contents;
calculating a length of information included in the multimedia contents; and
calculating the length of the media contents included in the multimedia contents from the length of the multimedia contents and the length of the information.
